(19) United States
(12) Patent Application Publication
(10) Pub. No.: US 2011/0063393 A1
(43) Pub. Date: Mar. 17, 2011

(54) PRINTER AND METHOD FOR RECORDING/ERASING IMAGE

(75) Inventor: Toshiharu SHIMOSATO, Shizuoka (JP)

(73) Assignee: TOSHIBA TEC KABUSHIKI KAISHA, Tokyo (JP)

(21) Appl. No.: 12/878,525

(22) Filed: Sep. 9, 2010

(30) Foreign Application Priority Data
Sep. 14, 2009 (JP) 2009-212274

(51) Int. Cl. B41J 2/325

(52) U.S. Cl. 347/179

(57) ABSTRACT

A printer prints on a recording medium having a recording surface whose visible image is recordable and erasable by the assignment of heat energy, and the recording medium has a wireless communicable IC inlet therein. The printer includes a guide conveying unit configured to convey the recording medium along a guide path, an image recording/erasing unit configured to record and erase a visible image by assigning heat energy of a thermal print head to the recording surface of the recording medium, and a control unit configured to control the image recording/erasing unit so as to assign a first temperature to a region where the IC inlet is not arranged, and so as to assign a second temperature higher than the first temperature to a region where the IC inlet is arranged when a visible image is erased.

### CROSS-REFERENCE TO RELATED APPLICATIONS

This application is based upon and claims the benefit of priority from Japanese Patent Application No. 2009-212274, filed on Sep. 14, 2009, the entire contents of which is incorporated herein by reference.

### FIELD

Embodiments described herein relate generally to a printer and a method for recording and/or erasing a visible image with respect to a rewritable-type recording medium including a wireless communicable IC inlet.

### BACKGROUND

Recently, technologies for wirelessly short-range communicating among IC inlets of articles have rapidly been distributed. Some types of printers use a print paper (recording medium) having a recording surface where a visible image is recordable, as an article. The print paper is mounted with an IC inlet, and the printers record the IC inlet along with printing the recording surface.

In some rewritable-type recording medium, visible images may be repeatedly recorded and erased in response to the application of heat energy. Such a recording medium has characteristics that a visible image is recorded by heating, the visible image is fixed by rapid cooling after heating, and the once-visualized image is erased by slow cooling after heating. If a recording medium is re-heated, a fixed visible image starts to be erased when the recording medium reaches a lower temperature than when the visible image is formed, and it is possible to repeatedly record and erase the visible image many times.

Additionally, some rewritable-type recording mediums are embedded with an IC inlet.

### BRIEF DESCRIPTION OF THE DRAWINGS

FIG. 1 is an illustration of an overall perspective view showing a paper feeder and a printer.

FIG. 2 is an illustration of a longitudinal side view thereof.

FIG. 3 is an illustration of a graph showing color developing characteristics of rewritable paper (recording medium).

FIG. 4 is a block diagram showing a hardware configuration of a printer,

FIGS. 5A to 5C are schematic diagrams illustrating a method of varying heat energy to be assigned to a recording surface of a rewritable paper (recording medium).

FIGS. 6A to 6C are schematic diagrams illustrating another method of varying heat energy to be assigned to a recording surface of a rewritable paper (recording medium).

FIG. 7 is a schematic diagram showing a state of heat energy assigned to a recording surface of a rewritable paper (recording medium) at the time of erasing a visible image.

FIG. 8 is a schematic diagram illustrating a control method for implementing the assignment of heat energy.

FIG. 9 is a flowchart showing a flow of a process of erasing a visible image.

FIG. 10 is an illustration of a view showing a rewritable paper embedded with an IC inlet.

FIG. 11 is a flowchart showing a flow of a process of erasing a visible image.

### DETAILED DESCRIPTION

A printer prints on a recording medium having a recording surface whose visible image is recordable and erasable by the assignment of heat energy, and the recording medium has a wireless communicable IC inlet therein. The printer includes a guide conveying unit configured to convey the recording medium along a guide path, an image recording/erasing unit configured to record and erase a visible image by assigning heat energy of a thermal print head to the recording surface of the recording medium, and a control unit configured to control the image recording/erasing unit so as to assign a first temperature to a region where the IC inlet is not arranged, and so as to assign a second temperature higher than the first temperature to a region where the IC inlet is arranged when a visible image is erased.

Embodiments will now be described in detail with reference to the drawings.

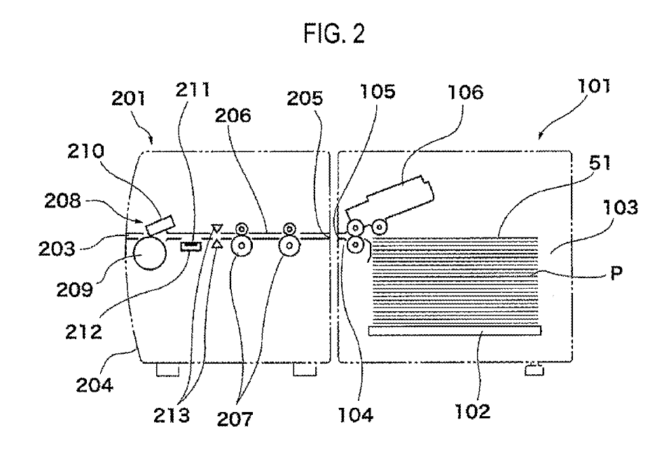

Embodiments provide printer 201 using rewritable paper P (see FIGS. 2, 7, and 8) as a recording medium, and an image erasing method for printer 201. Rewritable paper P has recording surface 51 whose visible image is recordable and erasable by assigning heat energy and has wireless communicable IC inlet 52 within recording surface 51.

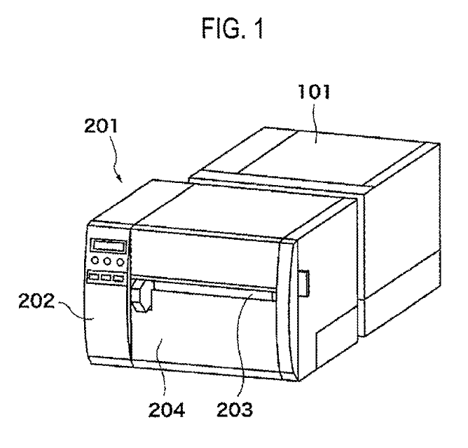

FIG. 1 is an overall perspective view showing paper feeder 101 and printer 201. Printer 201 of this embodiment is separate from paper feeder 101. Printer 201 includes operation display unit 202 and front panel 204 on the front-left side and the front-right side, respectively. Front panel 204 has paper discharging port 203 of rewritable paper P. Paper feeder 101 is combined to the backside of printer 201 to be internally connected to printer 201.

FIG. 2 is a longitudinal side view of paper feeder 101 and printer 201. Paper feeder 101 includes built-in paper storage unit 103 where each rewritable paper P is loaded, stored, and retained in a stack state on lifter 102. Paper storage unit 103 is connected to feed port 105 via paper feed path 104. Rewritable paper P is loaded on lifter 102 with recording surface 51 of rewritable paper P directed upwardly. Paper feeder 101 includes built-in pickup unit 106 for separating the top piece from a plurality of rewritable papers P stored in paper storage unit 103, and feeding the separated piece to paper feed path 104. Lifter 102 lifts a plurality of the stacked rewritable papers P by the amount of the consumption as pickup unit 106 feeds rewritable paper P.

Printer 201 includes paper feed port 205 on the rear. Paper feed port 205 is connected to feed port 105 installed at the end of paper feed path 104 built in paper feeder 101. Paper feed port 205 is connected to paper discharging port 203 formed on front panel 204 via guide path 206 for guiding rewritable paper P. Along guide path 206, two pairs of conveying rollers 207 (guide conveying unit) are arranged to convey rewritable paper P.

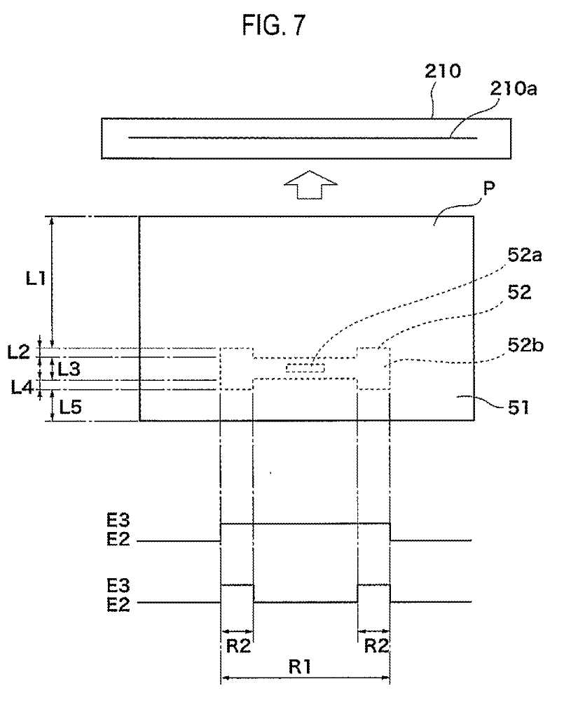

Printer 201 includes a built-in image recording/erasing unit 208 for recording and erasing a visible image by assigning heat energy to rewritable paper P. Image recording/erasing unit 208 is disposed around paper discharging port 203 at the end of guide path 206. Image recording/erasing unit 208 includes, among others, platen 209 (guide conveying unit) installed in guide path 206 and linear type thermal print head 210 in contact with platen 209 via guide path 206. Thermal print head 210 includes a plurality of heating elements 210a arranged in a line (see FIG. 7). If voltage is applied to heating elements 210a, heating elements 210a generate heat. Thermal print head 210 is installed above recording surface 51 of rewritable paper P. Thermal print head 210 may cause heating elements 210a to generate relatively high heat to an extent that recording surface 51 of rewritable paper P may be rapidly cooled after heating. Thereby, recording surface 51 of rewritable paper P may be rapidly cooled after heating elements 210a selectively generate heat, so that a visible image may be recorded on recording surface 51. Also, thermal print head 210 may cause heating elements 210a to generate relatively low heat to an extent that recording surface 51 of rewritable paper P may be slowly cooled after heating. Thereby, recording surface 51 of rewritable paper P may be slowly cooled after heating elements 210a collectively generate heat, so that a visible image may be erased. Platen 209 is installed below recording surface 51 of rewritable paper P, and rotates to convey rewritable paper P. In this configuration, thermal print head 210 is responsible for recording image in a main scan direction, and platen 209 is responsible for recording image in a sub scan direction.

Printer 201 includes a built-in antenna holding body 212 for holding antenna 211 of wireless communication unit 251. Antenna holding body 212 is arranged between pairs of conveying rollers 207 and image recording/erasing unit 208, which are located in the downstream of guide path 206. Wireless communication unit 251 uses antenna 211 to perform short-range wireless communication with IC inlet 52 in rewritable paper P. Antenna holding body 212 for holding antenna 211 is disposed below guide path 206, When IC inlet 52 is positioned opposite to antenna 211, wireless communication unit 251 wirelessly communicates with IC inlet 52.

Printer 201 further includes paper registration sensors 213 disposed ahead of antenna holding body 212 in the guide path 206. Paper registration sensors 213 detect rewritable paper P being conveyed by pairs of conveying rollers 207. After paper registration sensors 213 detects, wireless communication unit 251 connected to antenna 211 performs short-range wireless communication and image recording/erasing unit 208 records or erases a visible image in synchronization with the wireless communication based on the detection of paper registration sensors 213. For example, paper registration sensors 213 use transmission photo sensors.

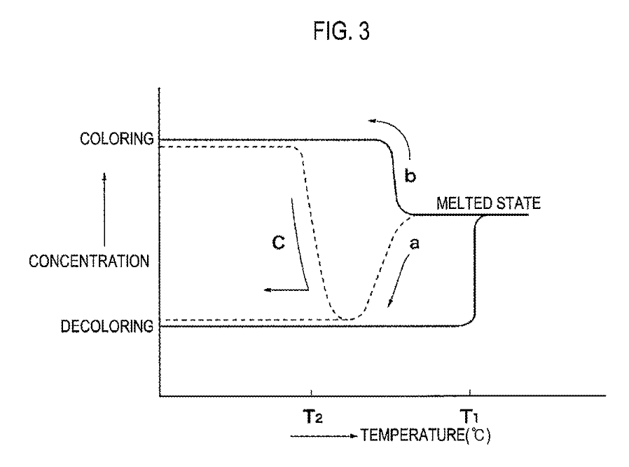

FIG. 3 is a graph showing color developing characteristics of rewritable paper P. Rewritable paper P is a recordable/erasable medium whose visible image is recordable or erasable by applying heat energy. Specifically, rewritable paper P is formed of reversibly thermo-sensitive recording layers including a leuco dye, or a color developer. The reversibly thermo-sensitive recording layers are multilayered on a medium surface of paper, or a resin film. Rewritable paper P has characteristics that print content is fixed by rapid cooling after heating and print content is erased by slow cooling after heating. Any medium capable of supporting information as an image may be used as a medium other than paper or a resin film. In rewritable paper P, reversibly thermo-sensitive recording layers are multilayered to form recording surface 51 whose visible image is recordable or erasable.

More specifically, as shown in FIG. 3, when a composite of reversibly thermo-sensitive recording layers in a decolored state is heated to exceed melting point temperature T1 of a color developer, the composite is melted to react with pigment of a leuco dye so as to be colored. When it is slowly cooled thereafter (see arrow a), the composite is decolored on the way of cooling and returns to be in the original decolored state. When it is rapidly cooled (see arrow b), a colored state is fixed. On the other hand, when a composite of reversibly thermo-sensitive recording layers in a colored state is heated from the state and a temperature increases (see arrow c), the composite is decolored at temperature T2, which is lower than coloring temperature as melting point temperature T1 of the color developer. If the increased temperature does not exceed melting point temperature T1 of the color developer, the composite remains in an original decolored state.

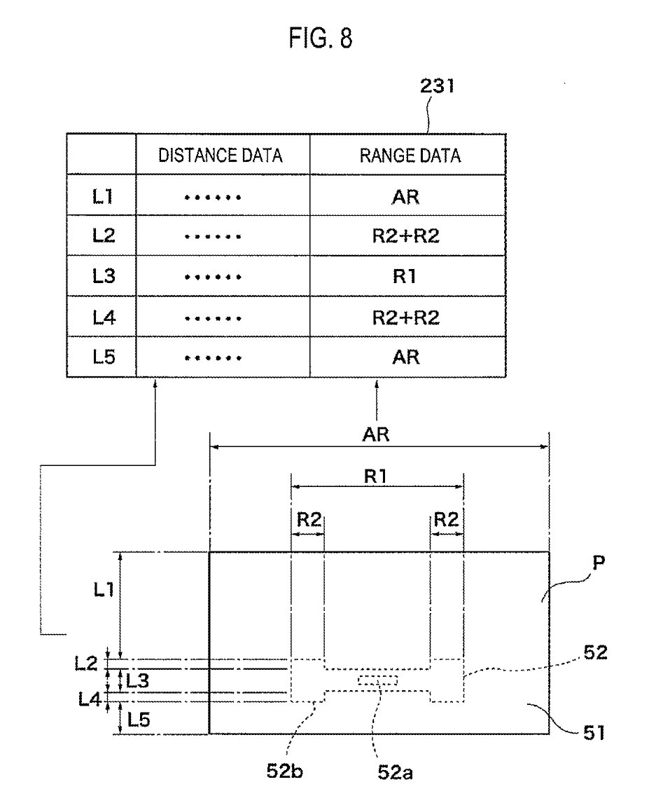

As described above, rewritable paper P whose visible image is recordable and erasable has built-in IC inlet 52 (see FIGS. 7 and 8). IC chip 52a is combined with antenna 52b to form IC inlet 52 (see FIGS. 7 and 8), and IC inlet 52 is built in rewritable paper P. In IC chip 52a, a processor and a memory are integrated as an integrated circuit. A passive type where electromotive force is supplied from an outside source is used as IC chip 52a in IC inlet 52.

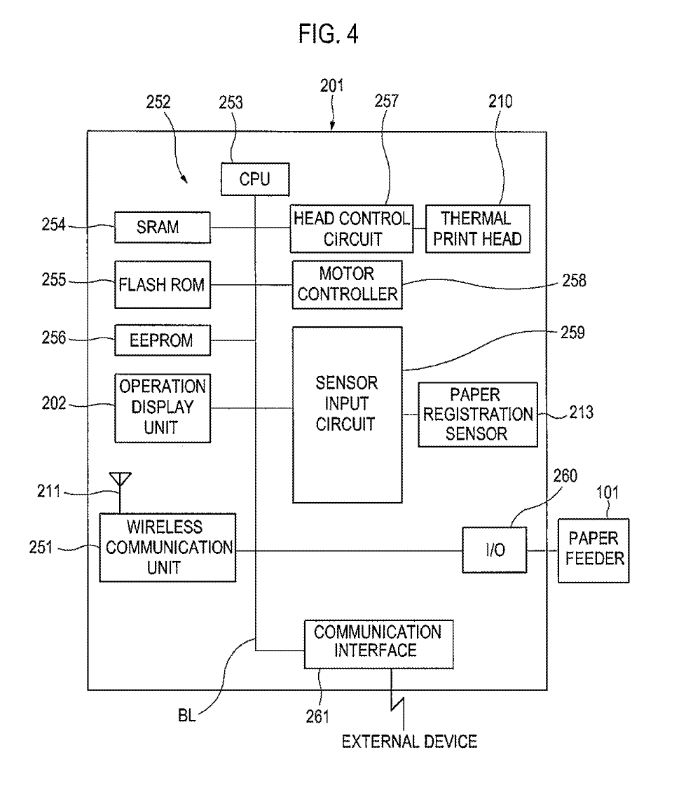

FIG. 4 is a block diagram showing the hardware configuration of printer 201. Printer 201 includes control unit 252 as a hardware resource for processing information. Control unit 252 is configured to connect SRAM 254, flash ROM 255, and EEPROM 256 to CPU 253 via bus line BL. The SRAM is used as a work area where variable data such as temporary storage data is rewritable and storable. ROM 255 is operable to rewrite and permanently store various types of variable data. EEPROM 256 stores a control program. CPU 253 of control unit 252 executes various processes according to the control program and causes printer 201 to record and erase visible information by controlling to drive individual parts.

Via bus line BL, CPU 253 is connected to head control circuit 257 for controlling thermal print head 210, motor controller 258 for controlling to drive pairs of conveying rollers 207 of a conveying system and a motor (not shown) for rotating platen 209 as a drive source, operation display unit 202, and sensor input circuit 259 for receiving a signal from paper registration sensor 213. Further, CPU 253 is connected to I/O 260 for connecting paper feeder 101 and communication interface 261 via bus line BL. Communication interface 261 may be connected to an external device (not shown), and allows printer 201 to communicate with the external device by supporting a communication protocol.

When printer 201 receives an image formation command from the external device via communication interface 261, printer 201 outputs an activation command to paper feeder 101 connected to I/O 260. In response to the activation command, paper feeder 101 picks up the top piece from pieces of rewritable papers P loaded on lifter 102 by pickup unit 106. Pickup unit 106 separates the top piece from other pieces of rewritable papers P located therebelow, and feeds the top piece to paper feed port 205 of printer 201 via feed port 105.

Control unit 252 of printer 201 inputs a drive signal into motor controller 258 in time. Thereby, pairs of conveying roller 207 and platen 209 of image recording/erasing unit 208 are driven to rotate. At this point, printer 201 receives rewritable paper P delivered from paper feeder 101 and conveys rewritable paper P using pairs of conveying rollers 207. Control unit 252 acquires the timing when paper registration sensor 213 detects rewritable paper P, and synchronously controls image recording/erasing unit 208 to record a visible image to recording surface 51 of rewritable paper P based on print data received along with the image formation command from the external device. Alternatively, if an image erasure command is received from the external device, image recording/erasing unit 208 is controlled to erase a visible image recorded on recording surface 51 of rewritable paper P. Thereafter, printer 201 discharges rewritable paper P whose visible image has been recorded or erased from paper discharging port 203.

In the course of recording a viable image on rewritable paper P or erasing a viable image from rewritable paper P, control unit 252 of printer 201 controls wireless communication unit 251 to perform short-range wireless communication with IC inlet 52 on which rewritable paper P is mounted. Control unit 252 uses wireless communication unit 251 to write IC chip 52a with record information for IC inlet 52, which is received along with the image formation command or the image erasure command from the external device. Otherwise, control unit 252 uses wireless communication unit 251 to read or erase information stored in IC chip 52a.

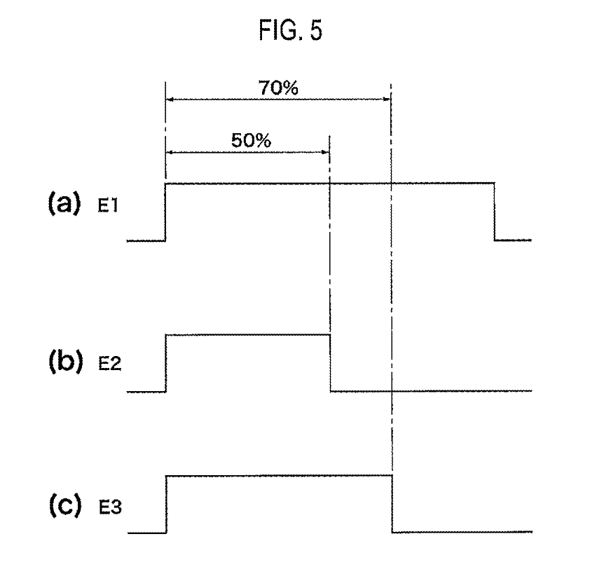

FIGS. 5A to 5C are schematic diagrams illustrating a method for varying heat energy to be assigned to recording surface 51 of rewritable paper P. Head control circuit 257 has a circuit configuration where current flows according to a strobe pulse for each of individual heating elements 210a in thermal print head 210. In this configuration, a pulse width of the strobe pulse defines current flowing time of head control circuit 257 for individual heating elements 210a. In this respect, for example, current for individual heating elements 210a flows in accordance with three types of strobe pulse widths of FIGS. 5A, 5B, and 5C.

FIG. 5A shows a strobe pulse width when a visible image is recorded on rewritable paper P. Each of heating elements 210a is driven with the strobe pulse to assign heat energy to recording surface 51 of rewritable paper P, which is sufficient to record a visible image. That is, recording surface 51 reaches more than melting point temperature T1 of a color developer included in a reversibly thereto-sensitive recording medium by the heat energy (see FIG. 3). As a result, recording surface 51 of rewritable paper P is rapidly cooled after heating elements 210a selectively generate heat, so that a visible image may be recorded on recording surface 51.

FIG. 5B shows a strobe pulse width when a visible image recorded on rewritable paper P is erased. For example, the strobe pulse width illustrated in FIG. 5B has 50% duty of the strobe pulse width illustrated in FIG. 5A. Thereby, heat energy assigned to recording surface 51 of rewritable paper P decreases less than the heat energy when heating elements 210a is driven with the strobe pulse width illustrated in FIG. 5A. At this point, the heat energy may erase a visible image recorded on recording surface 51. That is, when the heat energy is assigned, the temperature of recording surface 51 does not exceed melting point temperature T1 of a color developer included in a reversibly thermo-sensitive recording medium, but exceeds temperature T2 necessary for decoloring (see FIG. 3). As a result, recording surface 51 of rewritable paper P is slowly cooled after heating elements 210a collectively generate heat, so that a visible image recorded on recording surface 51 may be erased.

FIG. 5C also shows a strobe pulse width when a visible image recorded on rewritable paper P is erased. In a region where IC inlet 52 is installed in rewritable paper P, IC inlet 52 absorbs heat energy supplied from heating elements 210a. Thus, even though heating elements 210a are driven with the strobe pulse width illustrated in FIG. 5B, the temperature of recording surface 51 may not reach temperature T2 necessary for decoloring. In this respect, for example, in the region where IC inlet 52 is installed, heating elements 210a are driven with 70% duty of the strobe pulse width illustrated in FIG. 5A, which is greater than the strobe pulse width illustrated in FIG. 5B. Thereby, the heat energy absorbed by IC inlet 52 is supplemented to allow the temperature of recording surface 51 to reach temperature T2 necessary for decoloring. As a result, even in the region where IC inlet 52 is installed, recording surface 51 of rewritable paper P is slowly cooled after heating elements 210a generate heat, so that a visible image recorded on recording surface 51 may be erased.

In this respect, for the sake of convenience, it is assumed that the heat energy of heating elements 210a driven with the strobe pulse illustrated in FIG. 5A is E1, the heat energy of heating elements 210a driven with the strobe pulse illustrated in FIG. 5B is E2, and the heat energy of heating elements 210a driven with the strobe pulse illustrated in FIG. 5C is E3.

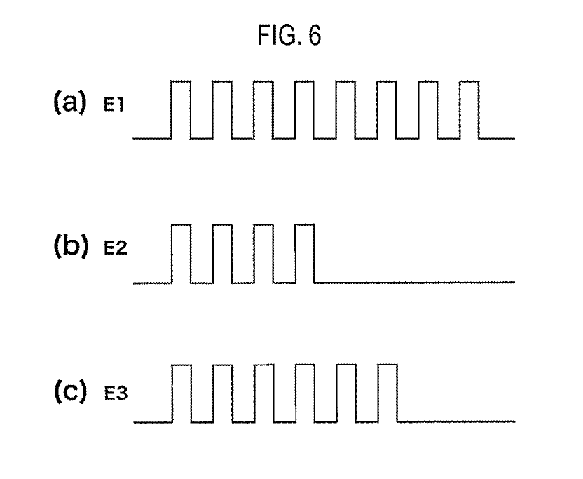

FIGS. 6A to 6C are schematic diagrams illustrating another method for varying heat energy to be assigned to recording surface 51 of rewritable paper P. In an example shown in FIGS. 6A to 6C, a strobe pulse per line is divided into a plurality of strobe pulses and heating elements 210a generate heat in response to the number of strobe pulses so that heat energy is controlled to be assigned to the recording surface of rewritable paper P. In this embodiment, for example, current flows for individual heating elements 210a with three types of strobe pulse number of FIGS. 6A, 6B, and 6C.

FIG. 6A shows the number of strobe pulses per line when a visible image is recorded on rewritable paper P. Each of heating elements 210a is driven with the strobe pulses to assign heat energy to recording surface 51 of rewritable paper P, which is sufficient to record a visible image. That is, recording surface 51 reaches more than melting point temperature T1 of a color developer included in a reversibly thermo-sensitive recording medium by the heat energy (see FIG. 3). As a result, recording surface 51 of rewritable paper P is rapidly cooled after heating elements 210a selectively generate heat, so that a visible image may be recorded on recording surface 51.

FIG. 6B shows the number of strobe pulses per line when a visible image recorded on rewritable paper P is erased. For example, the number of strobe pulses illustrated in FIG. 6B is the half the number of strobe pulses illustrated in FIG. 6A. Thereby, the heat energy assigned to recording surface 51 of rewritable paper P decreases as compared with when heating elements 210a are driven with the number of strobe pulses illustrated in FIG. 6A. At this point, the heat energy is that of an extent to which a visible image recorded on recording surface 51 is erasable. That is, by the heat energy, the temperature of recording surface 51 does not exceed melting point temperature T1 of a color developer included in a reversibly thermo-sensitive recording medium, but exceeds temperature T2 necessary for decoloring (see FIG. 3). As a result, recording surface 51 of rewritable paper P is slowly cooled after heating elements 210a collectively generate heat, so that a visible image recorded on recording surface 51 may be erased.

FIG. 6C also shows the number of strobe pulses per line when a visible image recorded on rewritable paper P is erased. The number of strobe pulses is for the region where IC inlet 52 is installed. That is, in the region where IC inlet 52 is installed, heating elements 210a are driven with the number of strobe pulses which is greater than the number of strobe pulses illustrated in FIG. 6B. Thereby, the heat energy absorbed by IC inlet 52 is supplemented to allow the temperature of recording surface 51 to reach temperature T2 necessary for decoloring. As a result, even in the region where IC inlet 52 is installed, recording surface 51 of rewritable paper P is slowly cooled after heating elements 210a generate heat, so that a visible image recorded on recording surface 51 may be erased.

Here, for the sake of convenience, it is assumed that the heat energy of heating elements 210a driven with the strobe pulses illustrated in FIG. 6A is E1, the heat energy of heating elements 210a driven with the strobe pulses illustrated in FIG. 6B is E2, and the heat energy of heating elements 210a driven with the strobe pulses illustrated in FIG. 6C is E3.

In order to vary the heat energy to be assigned to recording surface 51 of rewritable paper P, the adjustment of strobe pulse width illustrated in FIGS. 5A to 5C and the adjustment of the number of strobe pulses per unit time illustrated in FIGS. 6A to 6C may be appropriately combined.

FIG. 7 is a schematic diagram showing a state of heat energy to be assigned to recording surface 51 of rewritable paper P at the time of erasing a visible image. FIG. 7 schematically shows a state where rewritable paper P is conveyed to be directed to heating elements 210a of thermal print head 210 in the direction of an arrow. In this case, in view of a sub scan direction, rewritable paper P has region L1 from the leading end of rewritable paper P in the conveying direction to a portion where IC inlet 52 is not installed, regions L2 to L4 where IC inlet 52 is installed, and region L5 from a portion excluding IC inlet 52 to the rear end of rewritable paper P in the conveying direction. In this embodiment, both ends of IC inlet 52 have the lengths longer than the one of the center portion in a sub scan direction. Depending on the points where the length of IC inlet 52 changes in a sub scan direction, the region of IC inlet 52 is divided into three types of L2, L3, and L4.

When a visible image is erased, heating elements 210a of thermal print head 210 are respectively driven so that heat energy becomes E2 for the region where IC inlet 52 is not installed and heat energy becomes E3 for the region where IC inlet 52 is installed (see FIGS. 5 and 6). Regions L2 to L4 are where IC inlet 52 is installed in view of a sub scan direction of rewritable paper P, and region R1 and two regions R2 are where IC inlet 52 is installed in view of a main scan direction. That is, regions L2 and L4 of rewritable paper P in a sub scan direction are interconnected with two regions R2 in a main scan direction, and region L3 of rewritable paper P in a sub scan direction is interconnected with region R1 in a main scan direction.

Accordingly, control unit 252 of printer 201 drives heating elements 210a of thermal print head 210 as shown in Table 1.

TABLE 1

| | |
|---|---|
| Region L1 (sub) | Drive for heat energy of E2 |
| Region L2 (sub) | Drive for heat energy of E3 in two R2 (main) |
| | Drive for heat energy of E2 in other portions |
| Region L3 (sub) | Drive for heat energy of E3 in R1 (main) |
| | Drive for heat energy of E2 in other portions |
| Region L4 (sub) | Drive for heat energy of E3 in two R2 (main) |
| | Drive for heat energy of E2 in other portions |
| Region L5 (sub) | Drive for heat energy of E2 |

FIG. 8 is a schematic diagram illustrating a method for controlling to apply heat energy illustrated in FIG. 7. For example, printer 201 stores and holds definition file 231 (position data) illustrated in FIG. 8 in flash ROM 255. For individual rewritable papers P for printer 201, definition file 231 stores distance data and range data R in a main scan direction of IC inlet 52 in association with individual regions L1 to L5 in a sub scan direction. For example, the distance data is the number of pulses which motor controller 258 assigns to a motor to convey rewritable paper P. Since paper registration sensor 213 detects the position of leading end of the conveyed rewritable paper P, any position of the conveyed rewritable paper P may be recognized P by managing the number of motor pulses thereafter. At this point, if a value of distance data defined by definition file 231 is recognized, the position of IC inlet 52 in a sub scan direction is immediately determined. The range data defined by definition file 231 is the position where IC inlet 52 is installed in a main scan direction. The positions are in three types including AR indicating a total width of rewritable paper P, R1 indicating a total width of IC inlet 52, and R2 indicating only portions of the end of IC inlet 52.

If control unit 252 recognizes the distance data in association with regions L1 to L5 in a sub scan direction and the range date R of IC inlet 52 in a main scan direction defined in definition file 231, control unit 252 may recognize when the heating elements 210a are driven in a sub scan direction with heat energy E3 and which of the heating elements 210a are driven in a main scan direction with heat energy E3. In accordance with the recognition, control unit 252 sets the heat energy of heating elements 210a to E2 for the region where IC inlet 52 is not installed, and sets the heat energy of heating elements 210a to E3 for the region where IC inlet 52 is installed.

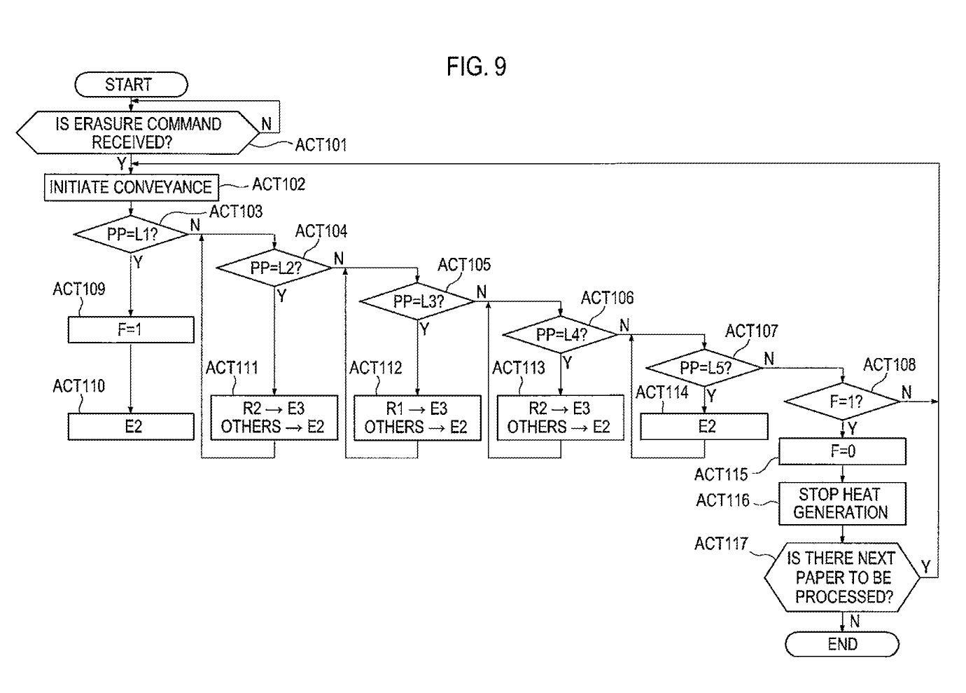

FIG. 9 is a flowchart showing a flow of a process of erasing a visible image. CPU 253 of control unit 252 executes a process shown in FIG. 9 according to a control program stored in EEPROM 256. First, if an erasure command is received from the external device via communication interface 261 (Y of ACT 101), CPU 253 outputs paper feed instructions to paper feeder 101 to initiate to convey rewritable paper P (ACT 102). A process of determining a position of rewritable paper P is executed (ACT 103 to ACT 107). At this point, once rewritable paper P is positioned with respect to region L1 in a sub scan direction, flag F is set to 1 as described later (ACT 109), so that rewritable paper P is known to be positioned with respect to region L1. On the other hand, if determinations of ACT 103 to ACT 107 are made in a state where rewritable paper P is not yet positioned with respect to region L1 in a sub scan direction, the state of flag F is checked out in subsequent ACT 108. If flag F is not 1 (N of ACT 108), the process returns to ACT 102.

When rewritable paper P is positioned with respect to region L1 in a sub scan direction (Y of ACT 103), CPU 253 sets flag F to 1 (ACT 109). Heating elements 210a of thermal print head 210 are driven to generate the heat energy of E2 according to definition file 231 (ACT 110). Thereby, for region L1 in a sub scan direction, a visible image recorded on recording surface 51 of rewritable paper P is erased.

When rewritable paper P is positioned with respect to region L2 in a sub scan direction (Y of ACT 104), CPU 253 drives heating elements 210a of thermal print head 210 to generate the heat energy of E3 for two regions R2 in a main scan direction and to generate the heat energy of £2 for other portions according to definition file 231 (ACT 111). Thereby, a visible image recorded on recording surface 51 of rewritable paper P is erased for region L2 in a sub scan direction. At this point, IC inlet 52 absorbs the heat energy of heating elements 210a, but the heat energy for the region is supplemented with the heat energy of E3, so that a visible image is well erased without leaving any residual.

When rewritable paper P is positioned with respect to region L3 in a sub scan direction (Y of ACT 105), CPU 253 drives heating elements 210a of thermal print head 210 to generate the heat energy of E3 for region R1 in a main scan direction and to generate the heat energy of E2 for other portions according to definition file 231 (ACT 112). Thereby, a visible image recorded on recording surface 51 of rewritable paper P is erased for region L3 in a sub scan direction. At this point, IC inlet 52 absorbs the heat energy of heating elements 210a, but the heat energy for the region is supplemented with the heat energy of E3, so that a visible image is well erased without leaving any residual.

When rewritable paper P is positioned with respect to region L4 in a sub scan direction (Y of ACT 106), CPU 253 drives the heating elements 210a of thermal print head 210 to generate the heat energy of E3 for two regions R2 in a main scan direction and to generate the heat energy of E2 for other portions according to definition file 231 (ACT 113). Thereby, a visible image recorded on recording surface 51 of rewritable paper P is erased for region L4 in a sub scan direction. At this point, IC inlet 52 absorbs the heat energy of heating elements 210a, but the heat energy for the region is supplemented with the heat energy of E3, so that a visible image is well erased without leaving any residual.

When rewritable paper P is positioned with respect to region L5 in a sub scan direction (Y of ACT 107), CPU 253 drives heating elements 210a of thermal print head 210 to generate the heat energy of E2 according to definition file 231 (ACT 114). Thereby, a visible image recorded on recording surface 51 of rewritable paper P is erased for region L5 in a sub scan direction.

CPU 253 checks out a flag state in ACT 108, and if flag F is 1 (Y of ACT 108), returns the flag to 0 (ACT 115). CPU 253 stops heating elements 210a (ACT 116). Then, CPU 253 determines whether or not the next rewritable paper P to be erased is present (ACT 117). If so, the process returns to ACT 102 (Y of ACT 117). Otherwise, the process ends (N of ACT 117).

According to this embodiment, a visible image is erased by setting a temperature assigned to a region where IC inlet 52 is arranged to be higher than a temperature assigned to a region where IC inlet 52 is not arranged when thermal print head 210 is driven with respect to rewritable paper P. Thereby, high-temperature heat energy that may cause to form a visible image is not assigned to a region where IC inlet 52 is not arranged, and heat energy that may erase a visible image by supplementing heat absorbed by IC inlet 52 is assigned to the region where IC inlet 52 is arranged. Accordingly, it is allowed to erase a visible image even in the region where IC inlet 52 is mounted.

According to this embodiment, control unit 252 determines a position where IC inlet 52 is arranged according to definition file 231 as preset position data, thereby easily detecting the position of IC inlet 52.

Further, in this embodiment, a visible image is erased by setting a temperature assigned to the region where IC inlet 52 is arranged to be higher than a temperature assigned to the region where IC inlet 52 is not arranged. On the other hand, the temperature assigned to the region where IC inlet 52 is arranged may be set to be higher than the temperature assigned to the region where IC inlet 52 is not arranged even at the time of recording a visible image as well as the time of erasing a visible image.

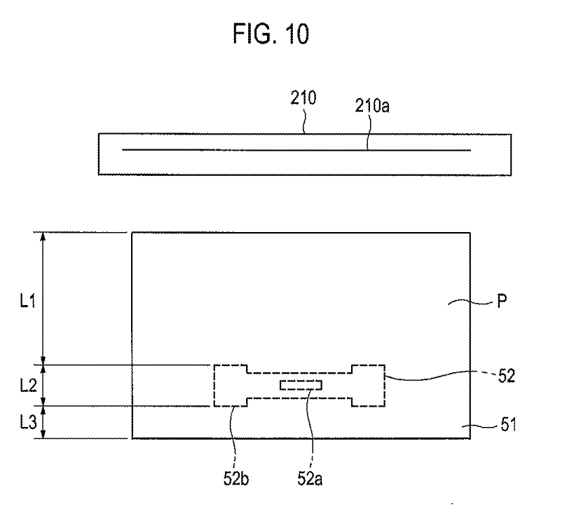

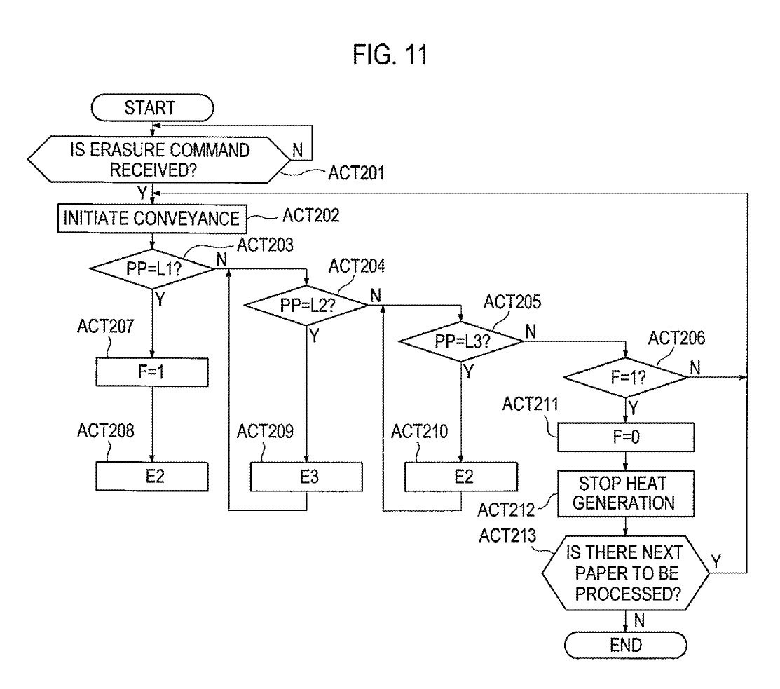

Next, some embodiments are described with reference to FIGS. 10 and 11, in which like numerals as mentioned above represent like elements. Further, for sake of simplicity, the above mentioned elements are not described below.

FIG. 10 shows rewritable paper P embedded with IC inlet 52. As described above, antenna 52b is combined with IC chip 52a integrating a processor, a memory chip, etc. to form IC inlet 52.

In this respect, in view of a sub scan direction, rewritable paper P has region L1 from the leading end of the conveying direction to a portion where IC inlet 52 is not installed, region L2 where IC inlet 52 is installed, and region L3 from a portion excluding IC inlet 52 to the rear end of the conveying direction.

When a visual image is erased, heating elements 210a of thermal print head 210 is driven to generate the heat energy of E2 for the regions where IC inlet 52 is not installed, and is driven to generate the heat energy of E3 for the regions where IC inlet 52 is installed.

TABLE 2

| | |
|---|---|
| Region L1 | Drive for heat energy of E2 |
| Region L2 | Drive for heat energy of E3 |
| Region L3 | Drive for heat energy of E2 |

FIG. 11 is a flowchart showing a flow of a process of erasing a visible image. CPU 253 of control unit 252 executes a process shown in FIG. 11 according to a control program stored in EEPROM 256. First, if an erasure command is received from the external device via communication interface 261 (Y of ACT 201), CPU 253 outputs paper feed instructions to paper feeder 101 to initiate to convey rewritable paper P (ACT 202). A process of determining a position of rewritable paper P is executed (ACT 203 to ACT 205). At this point, once rewritable paper P is positioned with respect to region L1 in a sub scan direction, flag F is set to 1 as described later (ACT 207), so that rewritable paper P is known to be positioned with respect to region L1. On the other hand, if determinations of ACT 203 to ACT 205 are made in a state where rewritable paper P is not yet positioned with respect to region L1 in a sub scan direction, the state of flag F is checked out in subsequent ACT 206. If flag F is not 1 (N of ACT 206), the process returns to ACT 202.

When rewritable paper P is positioned with respect to region L1 in a sub scan direction (Y of ACT 203), CPU 253 sets flag F to 1 (ACT 207). Heating elements 210a of thermal print head 210 are driven to generate the heat energy of E2 according to definition file 231 (ACT 208). Thereby, for region L1 in a sub scan direction, a visible image recorded on recording surface 51 of rewritable paper P is erased.

When rewritable paper P is positioned with respect to region L2 in a sub scan direction (Y of ACT 204), CPU 253 drives heating elements 210a of thermal print head 210 to generate the heat energy of E3 according to definition file 231 (ACT 209). Thereby, a visible image recorded on recording surface 51 of rewritable paper P is erased for region L2 in a sub scan direction. At this point, IC inlet 52 absorbs the heat energy of heating elements 210a, but the heat energy for the region is supplemented with the heat energy of E3, so that a visible image is well erased without leaving any residual.

When rewritable paper P is positioned with respect to region L3 in a sub scan direction (Y of ACT 205), CPU 253 drives heating elements 210a of thermal print head 210 to generate the heat energy of E2 according to definition file 231 (ACT 210). Thereby, a visible image recorded on recording surface 51 of rewritable paper P is erased for region L3 in a sub scan direction.

CPU 253 checks out a flag state in ACT 206, and if flag F is 1 (Y of ACT 206), returns the flag to 0 (ACT 211). CPU 253 stops heating elements 210a (ACT 212). Then, CPU 253 determines whether or not the next rewritable paper P to be erased is present (ACT 213). If so, the process returns to ACT 202 (Y of ACT 213). Otherwise, the process ends (N of ACT 213).

As used in this application, entities for executing the actions can refer to a computer-related entity, either hardware, a combination of hardware and software, software, or software in execution. For example, an entity for executing an action can be, but is not limited to being, a process running on a processor, a processor, an object, an executable, a thread of execution, a program, and a computer. By way of illustration, both an application running on an apparatus and the apparatus can be an entity. One or more entities can reside within a process and/or thread of execution and an entity can be localized on one apparatus and/or distributed between two or more apparatuses.

The program for realizing the functions can be recorded in the apparatus, can be downloaded through a network to the apparatus and can be installed in the apparatus from a computer readable storage medium storing the program therein. A form of the computer readable storage medium can be any form as long as the computer readable storage medium can store programs and is readable by the apparatus such as a disk type ROM and a solid-state computer storage media. The functions obtained by installation or download in advance in this way can be realized in cooperation with an OS (Operating System) in the apparatus.

While certain embodiments have been described, these embodiments have been presented by way of example only, and are not intended to limit the scope of the inventions. Indeed, the novel device and method described herein may be embodied in a variety of other forms; furthermore, various omissions, substitutions and changes in the form of the device and method described herein may be made without departing from the spirit of the inventions. The accompanying claims and their equivalents are intended to cover such forms or modifications as would fall within the scope and spirit of the inventions.

What is claimed is:

1. A printer configured to print on a recording medium having a recording surface whose visible image is recordable and erasable by the assignment of heat energy, the recording medium having a wireless communicable IC inlet therein, the printer comprising:
a guide conveying unit configured to convey the recording medium along a guide path;
an image recording/erasing unit configured to record and erase a visible image by assigning heat energy of a thermal print head to the recording surface of the recording medium; and
a control unit configured to control the image recording/erasing unit so as to assign a first temperature to a region where the IC inlet is not arranged, and so as to assign a second temperature higher than the first temperature to a region where the IC inlet is arranged when a visible image is erased.

2. The printer of claim 1, wherein the control unit is further configured to assign a third temperature higher than the second temperature to the recording surface when a visible image is recorded.

3. The printer of claim 1, wherein the control unit is configured to determine a position where the IC inlet is arranged in the recording medium according to preset position data.

4. The printer of claim 1, wherein the control unit is configured to selectively assign the respective temperatures to the recording surface by varying a pulse width of a strobe pulse assigned to the thermal print head.

5. The printer of claim 1, wherein the control unit is configured to selectively assign the respective temperatures to the recording surface by varying the number of strobe pulses per unit time assigned to the thermal print head.

6. The printer of claim 1, wherein the control unit slowly decreases the first and second temperatures after heating when a visible image is erased.

7. The printer of claim 2, wherein the printer is configured to discharge the recording medium from the printer so that the third temperature is rapidly decreased after heating when a visible image is recorded.

8. The printer of claim 1, wherein the region where the IC inlet is installed in the recording medium absorbs more heat energy than the region where the IC inlet is not installed in the recording medium.

9. The printer of claim 1, further comprising a wireless communication unit arranged ahead of the image recording/erasing unit along the guide path so as to provide wireless communication with the IC inlet.

10. A method for erasing an image comprising the acts of:
moving a thermal print head relatively with a recording medium, the recording medium having a recording surface whose visible image is recordable and erasable by providing heat energy, the recording medium having a wireless communicable IC inlet within the recording surface, and the thermal print head configured to erase a visible image by providing heat energy to the recording surface of the recording medium; and
erasing a visible image by setting a first temperature assigned to a region where the IC inlet is arranged to be higher than a second temperature assigned to a region where the IC inlet is not arranged at the time of moving the thermal print head relatively with the recording medium.

11. A method for recording/erasing an image comprising the acts of
moving a thermal print head relatively with a recording medium, the recording medium having a recording surface whose visible image is recordable and erasable by the assignment of heat energy and having a wireless communicable IC inlet within the recording surface, and the thermal print head configured to record and erase a visible image by assigning heat energy to the recording surface of the recording medium;
forming a visible image on the recording surface at the time of the relative movement by assigning a first temperature to the recording surface; and
erasing a visible image formed on the recording surface at the time of the relative movement by assigning a second temperature lower than the first temperature to a region where the IC inlet is not arranged and assigning a third temperature between the first temperature and the second temperature to a region where the IC inlet is arranged.

12. The method of claim 11, further comprising the act of detecting an arrangement position of the IC inlet according to preset position data.

13. The method of claim 11, wherein the act of erasing comprises selectively assigning the respective temperatures to the recording surface by varying a pulse width of a strobe pulse assigned to the thermal print head.

14. The method of claim 11, wherein the act of erasing comprises selectively assigning the respective temperatures to the recording surface by varying the number of strobe pulses per unit time assigned to the thermal print head.

15. The method of claim 11, wherein the act of erasing comprises slowly decreasing the first temperature and the second temperature in the printer after heating when a visible image is erased.

16. The method of claim 11, wherein the act of forming comprises discharging the recording medium from the printer to rapidly decrease the first temperature after heating when a visible image is recorded.

17. The method of claim 11, wherein the region where the IC inlet is installed in the recording medium is configured to absorb more heat energy than the region where the IC inlet is not installed in the recording medium.

18. The method of claim 11, further comprising the act of wirelessly communicating with the IC inlet before erasing the visible image formed on the recording surface.

19. The method of claim 18, wherein the act of communicating comprises erasing the information stored in the IC inlet.

20. A printer configured to print with a thermal head on a recording medium having a recording surface whose visible image is recordable and erasable by the assignment of heat energy, the recording medium having a wireless communicable IC inlet therein, the printer comprising:
a guide conveying unit configured to convey the recording medium along a guide path;
an image erasing unit configured to erase a visible image by assigning heat energy of a heat unit to the recording surface of the recording medium; and
a control unit configured to control the image erasing unit so as to assign a first temperature to a region where the IC inlet is not arranged, and so as to assign a second temperature higher than the first temperature to a region where the IC inlet is arranged when a visible image is erased.
